(19) United States
(12) Patent Application Publication
(10) Pub. No.: US 2006/0061482 A1
(43) Pub. Date: Mar. 23, 2006

(54) RFID auto-connect for wireless devices

(76) Inventors: Patrick Monney, Mex (CH); Roland Meyer, Dachsen (CH); Rene Sommer, Renens (CH); Gerhard Schneider, Mex (CH)

Correspondence Address: FENWICK & WEST LLP, SILICON VALLEY CENTER, 801 CALIFORNIA STREET, MOUNTAIN VIEW, CA, 94041, US

(21) Appl. No.: 10/950,361

(22) Filed: Sep. 23, 2004

(51) Int. Cl. H02J 13/00; H04Q 5/22

(52) U.S. Cl. 340/825.52; 340/10.52; 710/9

(57) ABSTRACT

A set of wireless devices can be coupled together using a radio frequency identification (RFID) system. The system includes an RFID writer for writing a unique identifier to an RFID tag stored in a transmitter device. The unique identifier can then be used to identify a wireless signal sent from the transmitter device to a receiver device. The receiver may also include an RFID tag, and the two devices may share a secret encryption key for use in creating an encrypted link between the transmitter and receiver. Virtual links may also be established at a distribution center by writing an address through a closed box into each device RFID. One or more RFID writers may be used to verify the identifier written to the RFID tags, carry out quality control checks, and track products to prevent inventory leaks and verify that sold products are certified.

### CROSS REFERENCE TO RELATED APPLICATIONS

This application is a continuation of U.S. patent application entitled “RFID Auto-Connect for Wireless Devices,” to Monney et. al. attorney docket number 19414-9327, filed Sep. 22, 2004, which is hereby incorporated by reference in its entirety herein.

### FIELD OF THE INVENTION

This invention relates generally to configuring a wireless device for communications with a receiver, and in particular, to using a radio frequency identification system to create a virtual communications link between a wireless device and a receiver.

### BACKGROUND OF THE INVENTION

Due to the widespread proliferation of wireless technology, it is now commonplace for multiple device-receiver pairs to be operating within the same frequency band in a single home or workplace environment. This has led to a greater risk of interference, both intentional, in the form of malicious eavesdropping, and unintentional, due to crosstalk between devices. An additional security threat may also be associated with remote-controlled devices that are susceptible to being manipulated by multiple wireless transmitters. One common technique to ensure that signals are received exclusively by their intended receiver within signal rich environments is to establish a unique identifier or address between each receiver-transmitter pair. This technique reduces the likelihood of interference and security risks associated with the technique previously described. The identifier is embedded in the signal transmitted from the sending device. The corresponding receiving device will only accept, report on, or otherwise react to received signals containing the correct identifier code. Signals received by the receiving device that do not contain the appropriate identifier code are ignored so there is no erroneous reporting by the receiving device.

This technique requires that a predefined identifier be stored in the * transmitting device. Conventionally, this can be accomplished by writing a unique address or identifier into read-only memory (ROM) (e.g., electronically erasable programmable ROM or EEPROM) of the transmitter and receiver. During the manufacturing process, for instance, the predefined identifier code is programmed into the EEPROM of the transmitter-receiver pair. The predefined identifier code will then be available when the sending device transmits data. The EEPROM can add substantial cost due to the EEPROM itself, the manufacturing process involved in placing and programming the EEPROM, and the physical space consumed by the EEPROM. A second drawback of this approach is that different components of the transmitter-receiver pair may be manufactured in different locations and at different times, to be matched to each other just prior to distribution or be distributed unmatched, requiring the user to complete the matching process. For instance, in the computer peripherals context, a receiver may be made at a distribution center in Europe, to be coupled with a keyboard assembled in Thailand and a mouse from China, and used with documentation manufactured by a local vendor. Matching the unique codes to components adds considerable administrative overhead and coordination between manufacturing sites.

Techniques have been devised to provide the code to the components post-distribution, for instance by using an auto-connect button that allows peripheral components to tune into each other while at the client site. However, such approaches may often be undesirable because they require the user to program their own devices prior to using them, imposing a configuration burden on the user and technical support costs on the supplier. In addition, in corporate environments where multiple transmitter-receiver pairs may operate within a small range, there is a chance that a device will be misprogrammed and associated with the wrong receiver or transmitter.

What is needed, therefore, is a technique that allows an identifying code or other virtual link to be distributed to transmitter-receiver pairs in a way that can be accomplished with minimal coordination and does not require user intervention. The technique should be implementable at the end of the supply chain, when components groups are coupled together into wireless systems just prior to distribution.

### SUMMARY OF THE INVENTION

In an embodiment, two devices of a wireless system can be communicatively associated using a unique identifier stored on a radio frequency identification (RFID) system. For example, code can be written to a first RFID tag in a first wireless device and to a second RFID tag in a second wireless device. The common code couples the two devices to each other, and can be used to identify one device to the other during communication. The step of writing to one or both of the RFID tags can be performed during the last stage of production when the devices of a wireless system are brought together. Because an RFID tag can be written to and energized wirelessly by a writer/reader, without requiring its own power supply, this step can flexibly be performed virtually at any time, including just before distribution eliminating the need to coordinate between production facilities in disparate locations.

Code written to an RFID tag can comprise any number of types of identifying data such as an address associated with the receiver or a key shared with the receiver. In an embodiment, a signal sent from the transmitter to the receiver can include the code or a variant of it to distinguish the signal's source. The RFID tag may be mounted to the printed circuit board of a device, and commands contained in the signal can be transferred over a signal line to be processed accordingly. In one embodiment, a common code is written to two devices; in another embodiment, however, a code can be read from a first RFID tag within the first device, and written to a second RFID tag within the second device. That way, the first RFID tag can be of the less expensive read-only tag class. When more than two devices are to be coupled together, for instance, in the case of one receiver and two transmitters, the devices may share a common code, written to each according to an anti-collision protocol.

An embodiment of the invention can be implemented in any wireless transmitter-receiver pair (e.g., mouse, keyboard, video camera, personal digital assistant, pointing device, remote control, etc) or system including more than one receiver or transmitter. It may be accomplished through a system comprising an RFID writer. The system may also include a reader, implementable for instance in a single writer/reader, in order to also verify that code written to an RFID tag is well-formed.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

Figure (or FIG.) 1 depicts a computer system including wireless peripheral components for use in accordance with an embodiment of the present invention.

FIG. 1A shows a prior art system for coupling the components of the computer system of FIG. 1.

FIG. 2 is a depiction of an electronic device and a remote control in accordance with an embodiment of the present invention.

FIG. 2A shows a prior art system for coupling the electronic device and the remote control of FIG. 2.

FIG. 3 depicts an RFID auto-connect system in accordance with an embodiment of the present invention.

FIG. 3A shows an RFID tag implanted on a printed circuit board in accordance with an embodiment of the present invention.

FIG. 3B shows an RFID tag in communication with a micro controller unit over an RF interface on a printed circuit board in accordance with an embodiment of the present invention.

FIG. 4 shows a manufacturing setup for writing to RFID tags included in the components of a wireless system in accordance with an embodiment of the present invention

FIG. 5 is a flowchart illustrating the production of an RFID auto-connect system according to one embodiment.

FIG. 6 is a flowchart illustrating the operation an RFID auto-connect system according to one embodiment.

FIG. 7 shows a pairing system for verifying the pairing status of a wireless system in accordance with an embodiment of the invention.

### DETAILED DESCRIPTION OF THE PREFERRED EMBODIMENTS

While the present invention will be described in connection with preferred embodiments thereof, it will be understood that it is not intended to limit the invention to those embodiments. On the contrary, it may not cover all alternatives, modifications, and equivalents as may be included within the spirit and scope of the invention as defined by the appended claims.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

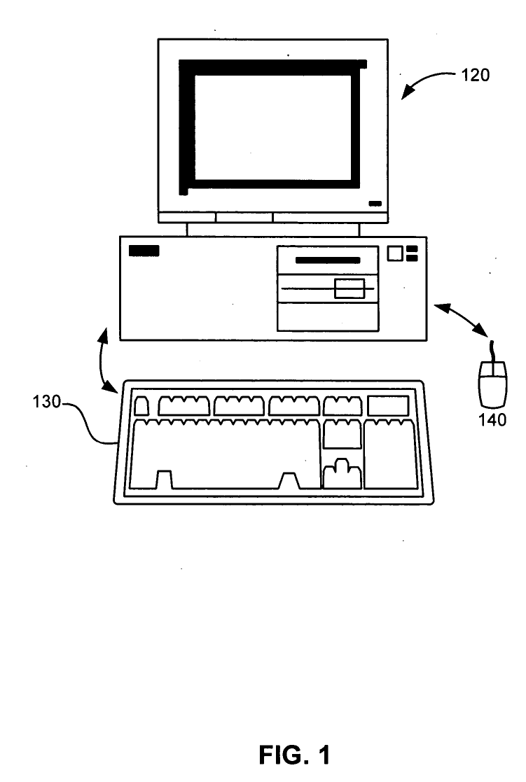

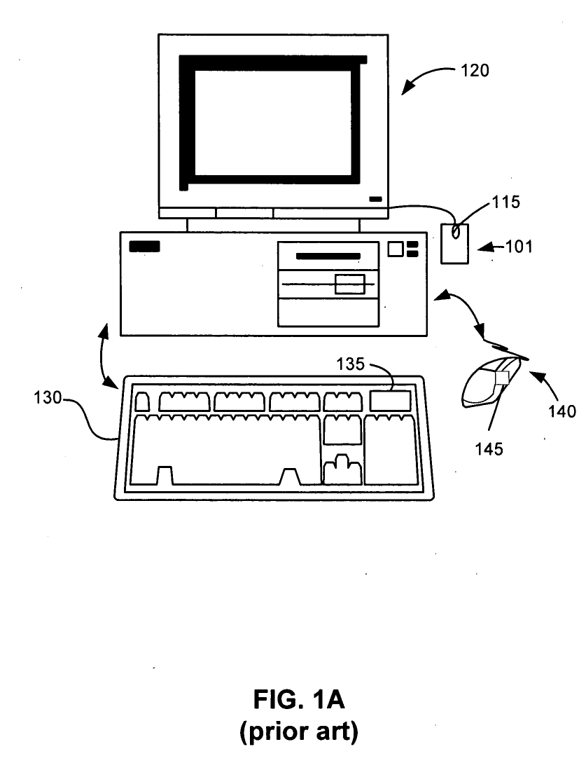

FIG. 1 illustrates a computer system in accordance with one embodiment of the present invention. The computer system includes a conventional computer 120 and peripheral devices 130, 140 coupled to the computer 120 through wireless connections. The computer 120 may be, for example, a personal computer, a workstation, a network computer (or appliance), or other computing device. The peripheral devices may include a keyboard 130 and a computer pointing device, e.g., a mouse 140. Other exemplary peripherals include devices such as printers, handheld control devices, game pads, joysticks, or steering wheels coupled to the computer. In addition, other devices such as remote controllers, cell phones, personal digital assistants, or other computers, computing devices, or laptops may be used to communicate with computer 120. Wireless keyboard 130 and mouse 140 transmit command and other signals to a host system (not shown) separately coupled to or included within computer 120. Commands received by the receiver are carried out by computer 120 to perform various operations; for instance, Internet browsing, application functions, and printing.

FIG. 1A shows a prior art system 101 for coupling the wireless keyboard 130 and mouse 140 to the computer 120. Using this system 101, a user depresses a connection button 135 that resides on the wireless keyboard 130 and another connection button 115 that resides on the host system 101. This causes the wireless keyboard 115 and the host system 101 to transmit data between them to establish an identifier for communication between the keyboard 115 and host 101. The same process is carried out with wireless mouse 140, on which another button 145 is pushed to establish a connection with host system 101. The identifier is stored by connected devices and used to identify communications, for instance, between the mouse 140 and host system 101. Commands received by host system 101 are transferred to computer 120. This prior art system has the disadvantage of requiring the user to carry out this connection step at home after purchasing the keyboard before being able to use it.

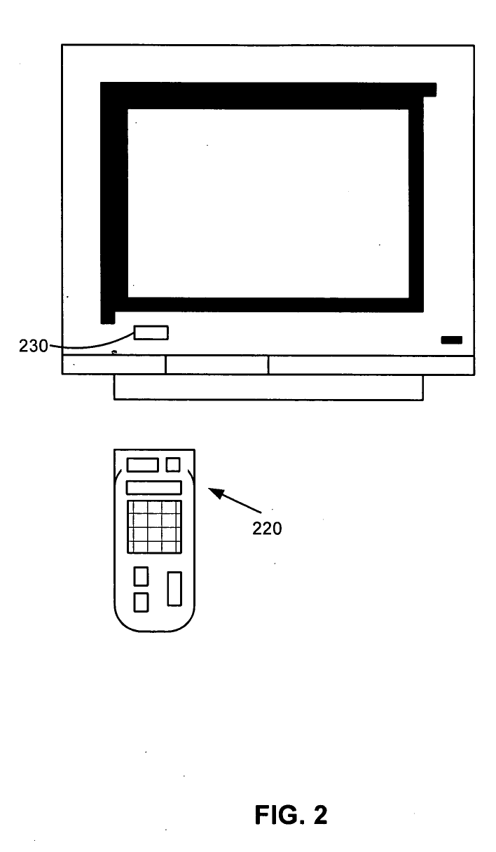

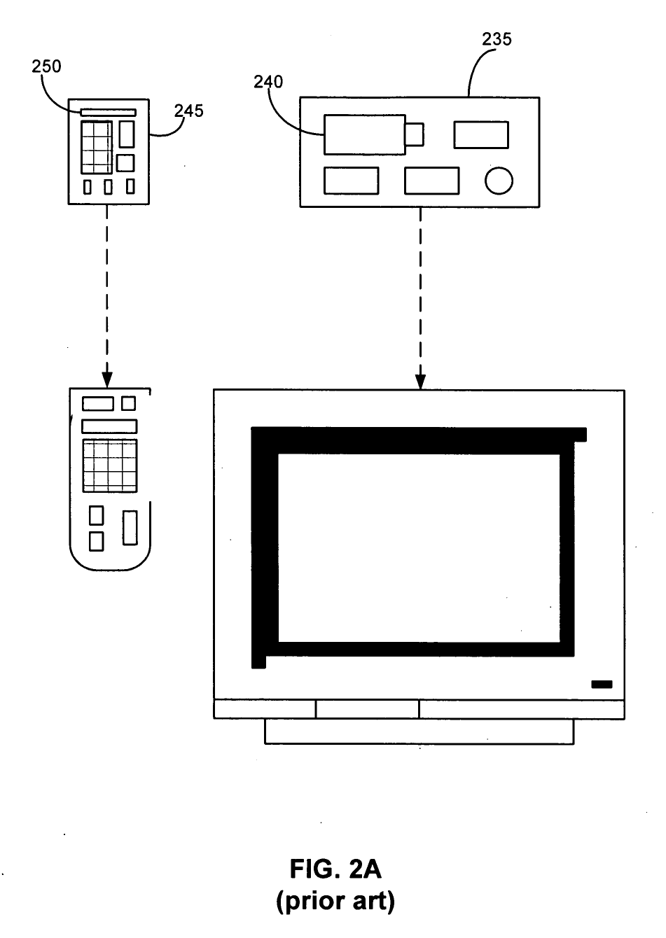

FIG. 2 depicts an electronic device 210 and a remote control 220 for controlling the device 210. The electronic device 210 shown is a television (TV); in other embodiments, it could also be a cordless telephone, digital camera, video camera, home entertainment system such as a stereo or DVD system, an entertainment computer for storing entertainment content, a personal video recorder (e.g., as supplied by TiVo Inc. of Alviso, Calif.), a home appliance, wireless doorbell, a set-top box, a computing, or other device. The remote control 220 communicates with the TV 210 over infrared (IR) transmissions, sent over a line of sight path between an infrared receiver 230 on TV 210 and the remote 220.

FIG. 2A shows a prior art system for coupling the electronic device 210 and remote control 220 of FIG. 2. Implanted on the printed circuit boards (PCB) 245, 235 of the remote and the TV, respectively, are memory modules 250 & 240. A transmission code is implanted on each module 250, 240 during the manufacturing process. This adds costs to and requires substantial coordination during the manufacturing process, particularly if the remote and TV are manufactured in different places.

RFID Auto-Connect System

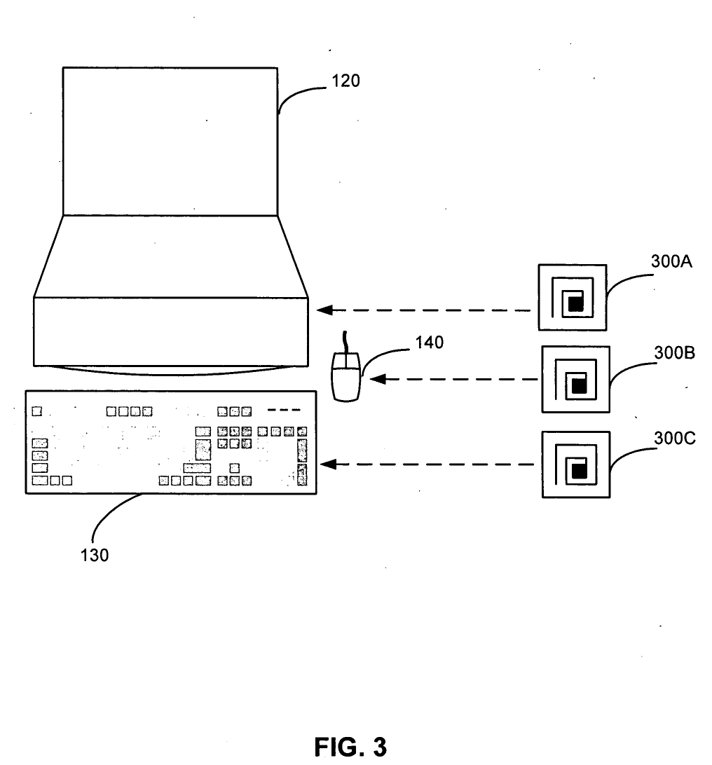

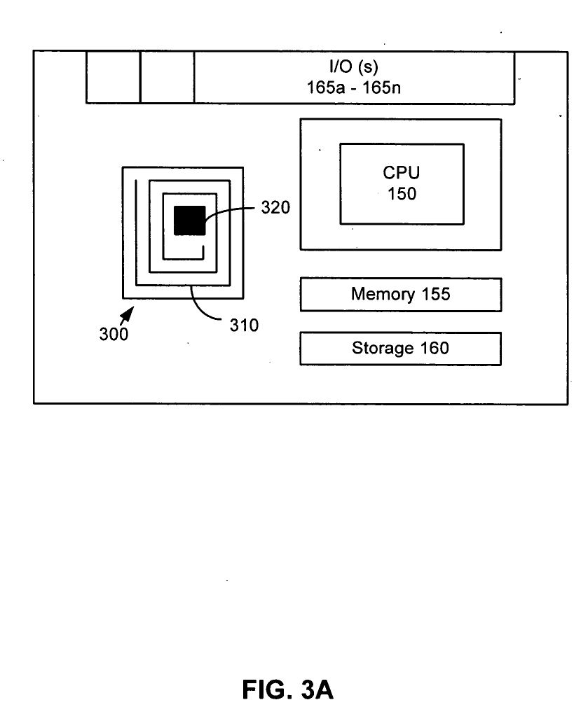

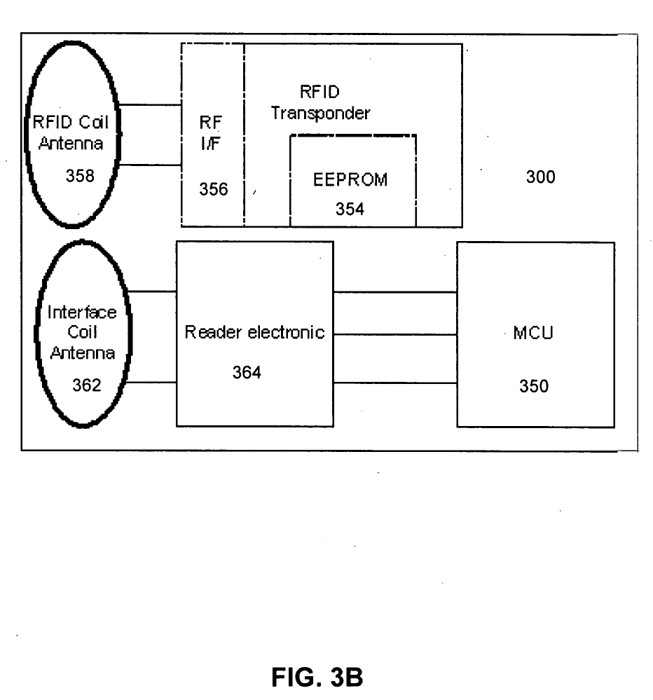

FIG. 3 depicts an RFID auto-connect system in accordance with an embodiment of the present invention. The system is comprised of RFID tags 300 mounted inside of wireless keyboard 130, mouse 140, and computer 120 of wireless computer system as shown. In an embodiment, each of the RFID tags 300 contains a common identifier or address that couples the components 120, 130, & 140 of the wireless system. During operation of the computer 120, command signals sent by transmitters within the peripheral devices (e.g., keyboard 130 and mouse 140) to a receiver or transceiver within the computer 120 include the identifier or address. The receiver or transceiver stored within the computer 120 or in a housing connected to computer 120, recognizes the command signals by the identifier, which is also embedded on its own RFID tag 300A, thereby distinguishing those signals from noise signals. This way, the receiver will report only on signals including the proper random identifier code.

In an embodiment, the RFID tags 300 are passive tags that can be encoded by an RFID writer without the need for an external power supply. Electromagnetic waves sent by a writer generate a current in the antennae of the tags 300 to power the microchip circuit and send a return signal to the writer. The writer can write the same address to the tags 300 within each device without any need to put the battery in those devices. This affords great flexibility in manufacturing operations, as, for example, the tags 300 can be inserted onto the printed circuit boards of wireless components 120, 130, 140 at one or more stages of production, and then encoded at the end of production when the components 120, 130, 140 are assembled together into a wireless system. This avoids the need to coordinate codes between the components 120, 130, 140 at an earlier stage in production, an administrative challenge when the components 120, 130, 140, are manufactured separately in different facilities and/or at different times, as is commonly the case.

RFID Tag

FIG. 3A illustrates an RFID tag 300 implanted on a logical internal architecture of a wireless device in accordance with one embodiment of the present invention. The exemplary architecture shown in FIG. 3A includes an RFID tag 300, central processing unit (CPU or processor) 150 (or microcontroller unit), a memory 155, a storage 160, one or more input-output (I/O) ports 165a-165n, and a data bus (not shown) that couples the components together. The CPU 150 is a conventional processor, for example, an Intel Pentium™ or Itanium™ series processor or a Motorola PowerPC™ series processor.

The system architecture configuration shown in FIG. 3A is exemplary in nature and shows the RFID tag 300 mounted to the main printed circuit board, in another embodiment, however, the RFID tag 300 could be mounted to a secondary printed circuit board, or could be connected to the CPU 150 via a data bus and not mounted directly onto a circuit board. The memory 155 is a conventional memory, for example, comprising dynamic random access memory (DRAM), static random access memory (SRAM), or EEPROM memory. The storage 160 is a conventional storage, for example, a magnetic storage medium, an optical storage medium, or a solid-state storage medium. Connecting the components is a conventional data bus, for example, a peripheral component interconnect (PCI) or an optical data bus. The I/O ports 165a-165n are conventional I/O ports, for example, a Universal Serial Bus (USB) port, a PS/2 port, an IEEE 1394 port, a parallel port, and/or a serial port. The I/O ports 165a-165n allow data from various peripherals to be provided to CPU.

The RFID tag 300 includes an antenna 310 for transmitting and receiving electromagnetic waves and a microchip 320 for storing information and doing simple processing. Although the antenna 310 shown is a rectangular antenna, it could also comprise a circular or loop antenna, an air coil antenna, or a printed antenna comprised of carbon paper ink. In an embodiment, the antenna 310 is positioned to optimize access by an RFID writer, for instance, on a production line. The RFID tag 300 may be coupled to the memory 155 by a data bus and can store identifier or other values provided by an RFID writer to the memory 155. In another embodiment, the RFID tag includes a small amount of memory and is coupled to the CPU 150 by a data bus line by which the CPU 150 can access the memory. Alternatively, the RFID tag 300 may be coupled to a memory 155 over an air interface.

In the alternative PCB configuration shown in FIG. 3B, the RFID tag 300 is in communication with a micro controller unit (MCU) 350 over an RF interface. The RFID 300 includes only an RF port, and does not have a serial port for communications with the MCU 350. Instead, information is transferred from the RFID 300 to the MCU 350 through the RFID antenna 358 to an RFID reader 364 that is in turn coupled to the MCU 350. In order to read an identifier or other value stored on the EEPROM 354 of the RFID tag 300, the reader sends a 364 sends a reading signal over its antenna 362 that is received by the RFID antenna 358. The RFID antenna 358 sends a response, which is received by the reader 364 through the reader antenna 362 and output to the MCU 350. This way, the RFID 300 tag only needs a single (RF) port.

The RFID tag 300 can be based on any existing or emerging RFID technology. The RFID tag 300 can be read-only, read/write, active, passive, semi-passive, or be of any of a variety of existing or emerging categories of RFID tags. The RFID tag 300 may have varying dimensions and be configured, for example, like a SO8 package or TSSOP8 package. Further, in one embodiment the RFID tag 300 is designed to operate at around 13.56 MHz and have a transmission and/or reception range of, for example, between 25 to 50 centimeters. Other frequencies and ranges are also possible including, inter alia, 125 KHz with a range below 10 cm, 915 MHz with a range between 3 to 5 meters, and 2.45 GHz with a range between 0.5 to 1 meter. Alternatively, a nonstandard frequency for RFID such as 27 MHz maybe used, as permitted by international regulation.

In accordance with an embodiment of the invention, an identifier or code is written to the RFID tag 300 that is used to couple the wireless device associated with the RFID tag 300 to other devices. The identifier or code can comprise a SHORT_ID that could, for example, describe the model of the devices (e.g. reflecting the number of buttons or feature set) and can follow any number of data formats. Alternatively, the identifier can consist of a multiple-bit address associated with the receiver, included directly in the transmissions of transmitters in peripheral devices.

In another embodiment, the identifier is used to seed a code-generating algorithm known to both a receiving and transmitting device, the result of which is included in transmissions between the receiving and transmitting device. The algorithm may comprise an encryption algorithm, and the RFID tag of a transmitter (e.g. stored in the keyboard of FIG. 3. 130) and a receiver (e.g. stored in the computer 120) can store a key commonly shared between the two devices for creating an encrypted link. For instance, based on a symmetric key algorithm like DES or AES and using 128-bit encoding, between the two devices. Upon receipt of an encrypted message, the receiving device can retrieve the encryption key from memory, and use it to decrypt the message. The chip included on one ore more of the RFID tags 300 may be capable of performing a cryptographic algorithm according to asymmetric-key encryption, challenge-response identification, or another protocol.

In yet another embodiment, one or more of the RFID tags 300 holds cryptographic protocol data, for use in encoding wireless transmissions. The information stored to the RFID tags 300 could alternatively comprise data for pairing the devices according to a Bluetooth protocol, or identification data to be used in tracking the wireless devices, including production or certification data to avoid product counterfeiting. In an embodiment, a single common identifier is stored to RFID tags 300 within each of the multiple components within a single wireless system; in another embodiment, different identifiers are stored within different wireless peripherals. For instance, RFID tags 300 within wireless keyboard 130 and mouse 140 are encoded with different identifiers, both of which are coded to RFID tag 300 within computer 120, in order to distinguish between the transmissions sent to computer 120 from the different components.

Programming RFID Tags of a Wireless System

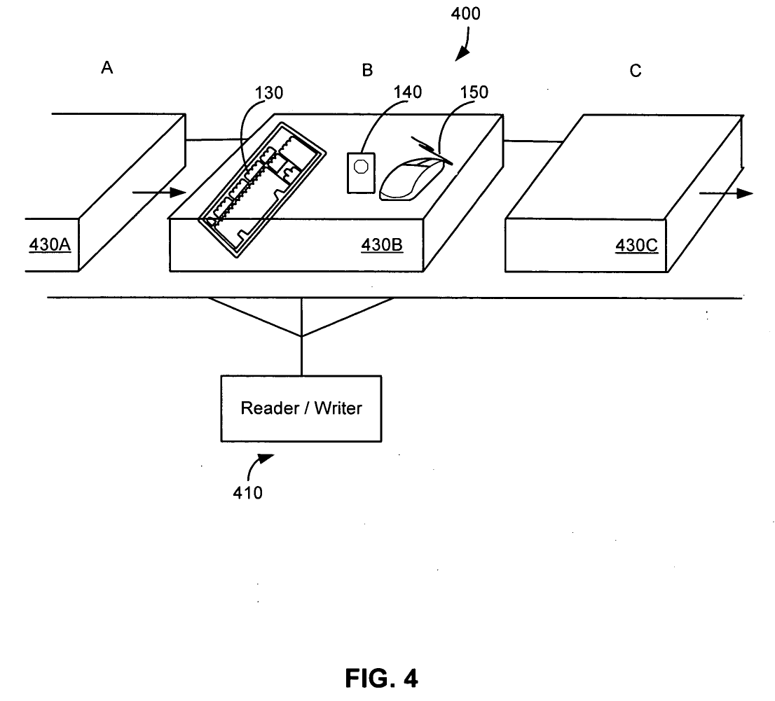

FIG. 4 shows a manufacturing configuration for writing to RFID tags included in the components of a wireless system in accordance with an embodiment of the present invention. Included is a “pairing station” comprising an RFID reader/writer 410, coupled wirelessly to a production line 400 carrying boxes 430 containing wireless systems. The wireless system of FIG. 4 comprises a wireless keyboard 130, a wireless mouse 140, and a receiver 150. Other embodiments, however, could include various remote controlled and wireless systems including wireless phones/receivers, wireless entertainment systems, and the like. Boxes 430 containing wireless systems progress down production line 400, through stages A, B, and C.

At stage B, the writer of the reader/writer 410 in the pairing station wirelessly writes a code or identifier to RFID tags included in a box 430B. The code or identifier may be randomly generated or serially assigned according to a manufacturing protocol. In an embodiment where the code comprises an ID and encryption key, the writer 410 may be coupled to or include a processor for generating a random key, of various encryption key lengths, using conventional methods known in the art such as a pseudo-random number generator, hash algorithm or microcontroller hardware timer. After the code has been written to the RFID tags, the reader of reader/writer 410 verifies the code written to each tag to ensure that it is well-written. Reader/writer 410 could comprise a handheld device, and/or be positioned in a variety of configurations and is located within range of RFID tags included in box. An advantage of using the RFID reader/writer 410 is that it writes to and reads from the RFID tag through RF waves and thus does not require direct access or line of sight to the tags. Taking advantage of this feature, in one configuration the RFID reader/writer 410 writes the common identifier to the tags through a closed box.

In another embodiment, to enable the devices to interoperate with other Bluetooth devices, the pairing station generates a random PIN (personal or private identification number) code for each of a wireless keyboard 130 and a wireless mouse 140. The writer of the reader/writer 410 is used to write these codes to each of the devices 130, 140. The reader of the reader/writer 410 is used to read the Bluetooth addresses from each device and writes the addresses and the PIN codes associated with the keyboard 130 and mouse 140 to the RFID tag in the receiver 101.

In another alternative embodiment of the invention, the identifier is written to the memory of a wireless device using a temporary wired network, rather than wirelessly. This could be still be accomplished while the wireless device is already packaged through a special conduit in the housing for the device, or access points such as plugs or holes in the device packaging. In addition, an optical link could be used to provide the coupling data to the devices.

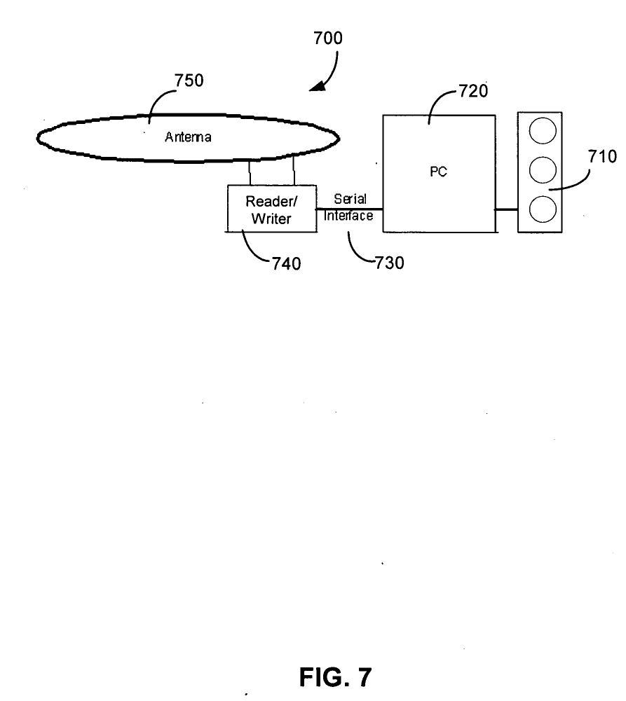

A pairing system 700 as shown in FIG. 7 can include a user interface 710 to indicate the progress of the pairing process. This interface 710 can indicate, for example, when the pairing station has detected all required transponders in its range, when the pairing in process, and if the pairing was successful. The pairing system 700 comprises an antenna 750 coupled to a reader/writer 740 for reading and writing to an RFID tag. The reader writer 740 is coupled over a serial interface 730 to a PC 720 that processes data provided by the reader/writer 740 and produces an output to the interface 710 that reflects the status of pairing.

In another embodiment, pairing is done after the devices have been shipped to an end-user, rather than during the production process. The receiver of a transmitter-receiver pair is equipped with a low-power RFID writer and/or reader that broadcasts read/write signals over a small range. When the receiver and a peripheral are brought within close proximity of each other, the writer within the receiver writes identifying data such as a numerical identifier or shared encryption key to an RFID tag stored within the peripheral device. The receiver and peripheral are paired. Advantageously, this allows peripheral and other devices and transmitters to be sold separately or matched from different systems. Thus, a user can buy a peripheral gaming accessory or a replacement peripheral and couple it to her existing gaming system.

A variety of pairing protocols is possible. For instance, separate and distinct IDs may be written into each peripheral device 130, 140 and these IDs written to an RFID tag of a receiver 150. The receiver 150 can identify commands sent by a wireless keyboard 130 because they include the code uniquely associated with the keyboard 130; likewise, signals sent by a mouse 140 can be distinguished by the separate code provided for communications sent from the mouse 140. In certain embodiments, the reader portion of the reader/writer 410 may be omitted, in others, the functionality of the reader/writer 410 may be provided by multiple devices.

In an embodiment, an RFID tag contained in a receiver device 150 is a read-only tag that already contains an identifying value. A reader of the reader/writer 410 reads this value from the RFID tag on receiver device 101 and a writer of the reader/writer 410 in turn writes the identifying value to RFID tags on the wireless keyboard 130 and wireless mouse 140. In order for the reader of the reader/writer 410 to read the identifiers written to the various devices (i.e. the keyboard 130, mouse 140, and receiver 101) the reader/writer 410 and tags follow an anti-collision protocol in order to distinguish between RFID signals sent from the various devices 130, 140. This anti-collision protocol can be implemented according to a singulation protocol under which tags take turns transmitting to the reader of the reader/writer 410. Following such a protocol, the reader of the reader/writer 410 may send various switch-on, switch-off, acknowledge, and retry signals to tags in wireless devices 130, 140, 150. Responsive to these signals, signals may be broadcast by antennae of RFID tags at varying times. In one embodiment, each RFID has its own unique identifier and the reader can choose the RFID tag with which the reader wants to communicate. Alternatively, each RFID has one of a set of identifiers that the reader and/or writer of the reader/writer 410 use to specify the intended recipient of the signal. A binary tree scanning anti-collision protocol which implements the “reader talks first” methodology well-known in the art may also be used. Under such a protocol, no tag transmits any information prior to a request by a reader.

In another embodiment, peripheral devices operating at different frequencies can communicate with the receiver according to a standard such as Bluetooth, Shared Wireless Access Protocol (SWAP), IEEE 802.11, or IEEE 802.15. Alternatively, a wireless bridge can be used to accomplish pairing. Various wireless bridges are described in more detail in U.S. patent application Ser. No. 09/507,768, which is herein incorporated by reference in its entirety. Using any of these methods or systems, a user could send a print command from a handheld device to a receiver in a computer that is in turn coupled to a print server.

Production of an RFID Auto-Connect System

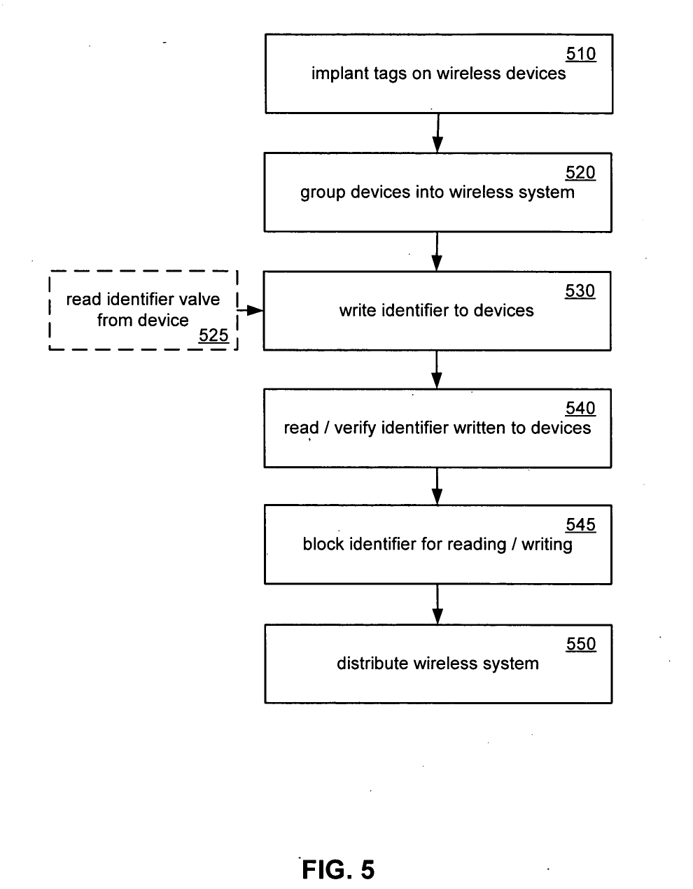

FIG. 5 is a flowchart illustrating the production of an RFID auto-connect system according to one embodiment. RFID tags are first implanted 510 on various wireless devices at various stages of production, commonly when components are being mounted to the printed circuit board of each device. As this stage, the RFID tags can comprise blank tags to be written to later in the manufacturing process. In the embodiment, however, a read-only RFID tag with a pre-stored code is implanted to a receiver device, to later be read from the RFID tag and encoded on the one or more transmitter devices to be used with the receiver device.

At the next stage in the process, wireless devices, in the example shown in FIG. 5, are grouped 520 into a wireless system, for example at an assembly facility where components manufactured in different geographic locations are brought together for packaging prior to distribution. For instance, devices are put into packages and placed on an assembly line.

In an optional step, a pre-stored identifier value is read 525 by an RFID reader from an RFID tag in a first device. This identifier value is provided to an RFID writer, and is written 530 to RFID tags contained in the other elements of the wireless system. In another embodiment, step 525 is omitted, and a common identifier is written 530 by an RFID writer to read/write tags in all elements of the wireless system. The identifier is then read and verified 540 by an RFID reader. Once the information is verified 540, the information is blocked 545 for reading and writing, and the resulting lock is verified.

Steps in the process shown in FIG. 5 can be carried out just before the final assembled box is distributed 550, for example to retailers. Further, a quality control system, for example, comprised of a handheld or other reader may be used at a later point in the process (not shown) to verify that the components all share the same common identifier. If devices in a wireless system are mismatched, they may be reprogrammed, according to steps 530 and 540 as shown in FIG. 5 and described previously.

In addition, an embodiment may also be configured to allow one or more readers for use in tracking and monitoring, for example, an analysis of error logs of returned units or for tracking and detecting an uncertified device. In another embodiment, one or more RFIDs in the wireless system are programmed at one stage in the production and are used to track production of the wireless system during subsequent phases of the supply chain.

Operation of an RFID Auto-Connect System

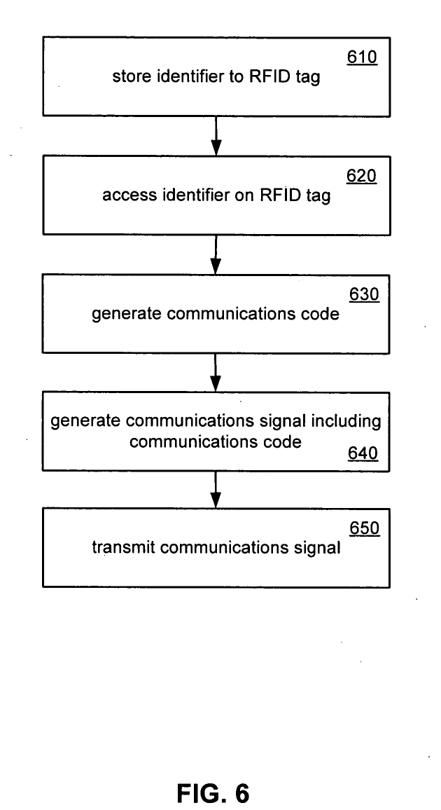

Referring now to FIG. 6, a flowchart illustrates operation of an RFID auto-connect system from the perspective of an RFID tag on a wireless transmitter in a wireless device according to one embodiment. The RFID identifier is stored 610 to the tag during the manufacturing process. During the process of sending a command from transmitter to a receiving device, the identifier is accessed 620, and used to generate 630 a communications code.

The wireless transmitter generates 640 a communications signal that includes the communications code generated 630 based on the identifier and transmits 650 it to a receiver. In a system where there are multiple transmitters sending signals to a common receiver, the step of generating 640 a communications signal may be carried out in accordance with one of a number of possible protocols for distinguishing between signals sent from the different transmitters. For example, in an embodiment the format of the data field will vary with the type of wireless peripheral device and the type of message. Alternatively, headers may be used to identify to the user the type of device, including address or sub-address information relevant to the transmitting device. The communications signal is transmitted 650 and the source of the signal is identifiable by the code contained in the signal.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for coding a first device and a second device to facilitate wireless coupling therebetween, the method comprising:
writing a unique identifier to a first radio frequency identification (RFID) tag within the first device; and
writing the unique identifier to a second RFID tag within the second device.

2. The method of claim 1, wherein the first RFID tag within the first device comprises a passive RFID tag.

3. The method of claim 1, wherein the identifier comprises one selected from the group consisting of: an address, a shared key, a randomly generated ID, cryptographic protocol data, and a PIN for use with a Bluetooth device.

4. The method of claim 1, wherein the first device is a receiver or a transceiver.

5. The method of claim 4, wherein the receiver is coupled to an electronic device selected from a group consisting of: a computer, a video camera, an entertainment system, a recording device, a network device, a television, a set-top box, and a home appliance.

6. The method of claim 1, wherein the second device is a peripheral device.

7. The method of claim 6, wherein the peripheral device comprises one selected from a group consisting of: a remote control, a wireless keyboard device, a wireless mouse, a wireless trackball, a wireless joystick, a wireless keypad device, and a printer.

8. The method of claim 1, further comprising:
reading the first or the second RFID tag to verify the identifier written thereto.

9. The method of claim 7, further comprising:
blocking the identifier for reading and writing.

10. The method of claim 1, further comprising:
writing a second unique identifier to a third RFID tag within a third device; and
writing the second unique identifier to the first RFID tag within the first device to facilitate wireless coupling between the first device and the third device.

11. The method of claim 1, wherein the first RFID tag has a single port for communications.

12. A system for associating a unique identifier with a plurality of devices to facilitate wireless coupling therebetween, the system comprising:
an RFID writer for wirelessly writing a unique identifier to an RFID tag stored in a transmitter device, the unique identifier suited for use in identifying a wireless signal sent from the transmitter device to the receiver device.

13. The system of claim 12, wherein:
the RFID writer is configured to receive a unique identifier read by the RFID reader from a first RFID tag in a first device, and to write the unique identifier to a second RFID tag in a second device, for wireless coupling between the first and second device.

14. The system of claim 12, further comprising an RFID reader configured to read an RFID tag for verifying an identifier written thereto.

15. The system of claim 12, further comprising anti-collision logic for distinguishing a signal sent to a device among a plurality of devices.

16. The system of claim 15, wherein the RFID writer is configured to transmit an anti-collision signal selected from the group consisting of: a switch-on signal, a switch-off signal, an acknowledge signal, and a retry signal.

17. The system of 15, wherein the RFID writer is configured to identify an intended recipient of an RFID signal generated by the writer by including an identifier uniquely associated with the intended recipient device in the signal.

18. A wireless communications system comprising:
a transmitter circuit for transmitting a wireless signal, the signal including a communications code derived from a unique identifier stored on an RFID tag coupled to the transmitter circuit.

19. The wireless communications system of 18, wherein the unique identifier comprises one selected from the group consisting of: an address associated with a receiving device, a key shared with a receiving device, a PIN number shared with a receiving device, and cryptographic protocol data associated with a receiving device.

20. The wireless communications system of 18, wherein the transmitter circuit is included in one selected from the group consisting of: a remote control, a wireless keyboard device, a wireless mouse, a wireless trackball, a wireless joystick, a wireless keypad device, and a wireless appliance.

21. The wireless communications system of 18, wherein the communications code is suited to identify a wireless signal sent from the transmitter circuit to a receiving device.

22. A wireless communications system comprising:
a receiver circuit for receiving a wireless signal, the receiver circuit coupled to an RFID tag storing a unique identifier for identifying by the receiver circuit the source of the wireless signal.

23. The wireless communications system of claim 22, wherein the unique identifier comprises one selected from the group consisting of: an address associated with a sending device, a key shared with a sending device, and cryptographic protocol data associated with a sending device.

24. The wireless communications system of claim 22, wherein the receiver circuit is included in one selected from a group consisting of: a computer, a video camera, an entertainment system, a recording device, a network device, and a home appliance.

25. A wireless communications system comprising:
a first circuit for transmitting a wireless signal, the signal including a communications code derived from a unique identifier stored on an RFID tag coupled to the transmitter circuit; and
a second circuit communicatively coupled to the first circuit, the second circuit for receiving the information communicated by first circuit, wherein the information includes the communications code.

26. A method for distinguishing transmissions of a wireless transmitter, the method comprising:
writing to an RFID tag a unique identifier for identifying the source of a wireless signal generated by the wireless transmitter.

27. A method for coding a second device with a unique identifier associated with a first device to facilitate wireless coupling therebetween, the method comprising:
reading a unique identifier from a first RFID tag within the first device; and
writing the unique identifier from the first device to a second RFID tag within the second device.

28. The method of claim 27, wherein the first RFID tag comprises a read-only tag, and the second RFID tag comprises a read-write tag.

29. A wireless system comprising:
a first device including a first RFID tag and an RFID reader/writer; and
a second device including a second RFID tag, wherein the RFID writer is configured to read a value from the first RFID tag and write it to the second RFID tag to facilitate wireless coupling therebetween.
